(19) United States
(12) Patent Application Publication
(10) Pub. No.: US 2011/0012720 A1
(43) Pub. Date: Jan. 20, 2011

(54) Integration of Vehicle On-Board Diagnostics and Smart Phone Sensors

(76) Inventor: Robert A. Hirschfeld, Austin, TX (US)

Correspondence Address: Robert A. Hirschfeld, 4900 Timberline Dr, Austin, TX, 78746, US

(21) Appl. No.: 12/836,576

(22) Filed: Jul. 14, 2010

Related U.S. Application Data
(60) Provisional application No. 61/270,881, filed on Jul. 15, 2009.

(51) Int. Cl. G06F 7/00; H04W 4/00; B60Q 1/00

(52) U.S. Cl. 340/439; 701/33; 455/426.1

(57) ABSTRACT

An integration between data from the on-board diagnostic system of a vehicle and the sensors contained in a personal communication device or smart phone. The data integration enables improved diagnostic information to be provided to the driver. In addition, data can be distributed to remote systems using the device's network connection for additional analysis and comparison. Remote data can be used in aggregate by 3^{rd} parties or sent back to the driver to further inform her driving choices.

### CROSS-REFERENCE TO RELATED APPLICATIONS

This application claims the benefit of U.S. Provisional Applications Ser. No. 61/270,881, filed on Jul. 15, 2009 which is herein incorporated by reference in its entirety for all intents and purposes.

This application references components of U.S. application Ser. No. 12/624,409, filed on Nov. 24, 2009 and U.S. application Ser. No. 12/614,401, filed on Nov. 7, 2009.

### BACKGROUND OF THE INVENTION

1. Field of the Invention

The present invention relates in general to communicating on-board diagnostic information as an audio signal, such as for use by a personal communication device.

2. Description of the Related Art

Vehicle On-Board Diagnostics (OBD) interfaces are standardized by statute on all modern vehicles. These interfaces conforms to both physical and protocol specifications. The communication protocols used by OBD include serial (e.g.: RS-232) and controller area network (CAN). There are at least 5 different standards based protocol specifications in use for current OBD systems including SAE J1850 PWM/VPW, ISO 9141-2, ISO 14230 KWP2000, and ISO 15765 CAN. Starting in 2008, all US vehicles must use ISO 15765 CAN based communication protocols for the OBD interface. Various standards are known for OBD, such as OBD-I, OBD 1.5, and OBD-II which include various standard interfaces, signal protocols, data communications, etc. The present disclosure contemplates future OBD configurations and implementations.

Smart phones or personal communication devices (PCD) have been widely available from companies such as Research In Motion (RIM). Recent introduction of the iPhone® by Apple Inc. and Android by Google phones have accelerated market penetration of these devices. Smart phones provide a broad range of capabilities, such as large readable displays, the ability to add new applications to the phone, network connectivity via cellular and/or WiFi, and global positioning system (GPS) location determination.

OBD display devices from companies including Autotap, ScanGauge allow drivers to display diagnostic data using a dedicated device and display. These after-market products allow drivers to monitor car diagnostics including fuel economy.

Integrated vehicle diagnostic displays are included in some automobile dashboards or displays to show current and average fuel economy.

### BRIEF DESCRIPTION OF THE DRAWINGS

The benefits, features, and advantages of the present invention will become better understood with regard to the following description, and accompanying drawings where:

FIG. 1 is a block diagram of an integrated driving application that combines data from an on-board diagnostics system and sensor data from a personal communication device;

FIG. 2 is a block diagram of an integrated driving application uses sends and receives data from an on-board diagnostics system and sensor data from a personal communication device to a remote data service in order to share information about driving behavior;

FIG. 3 is an user interface illustration showing the use of data that combines OBD and phone data.

FIG. 4 is an user interface illustration showing the use of both local and remote data to provide improved feedback.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The implementation of this invention relies on integrating information from both OBD and phone.

The invention involves advanced applications created by combining information from the vehicle's OBD port and the phone's accelerometer and location sensors. This combination is a new and novel integration of data that provides unique value to drivers.

The following uses of integrated data are contemplated:

| Application | OBD Data | Phone Data |
|---|---|---|
| Too aggressive acceleration for | Velocity | Accelerometer |
| road conditions | Fuel Usage | Location |
| | Temperature | Weather Information |
| Ineffective acceleration | Velocity | Accelerometer |
| | Fuel Usage | |
| Too aggressive braking for road | Velocity | Accelerometer |
| conditions | Tire pressure | Location |
| Reduce efficiency target while | Fuel Usage | Accelerometer |
| climbing hills | Velocity | Location |
| Increase efficiency target while | Fuel Usage | Accelerometer |
| descending hills | Velocity | Location |
| Emergency braking | Velocity | Accelerometer |
| | Tire pressure | Microphone |
| | Anti-lock brake condition | |
| Brake efficiency test | Velocity | Accelerometer |
| | Tire pressure | |
| Location targeted fuel efficiency | Fuel Usage | Location |
| (e.g.: higher on highways) | | |
| Pollution Reporting | Fuel Usage | Location |
| | Catalytic Converter State/ | |
| | Temperature | |
| Traffic Reporting | Velocity | Location |
| | | Accelerometer |
| Automated maintenance request | Trouble codes | Location |
| Determine uneven tire wear | Tire pressure | Accelerometer |
| Accident Report | Vehicle Identification Number | Location |
| | (VIN) | Accelerometer history |
| | Trouble codes | |
| | Last speeds tracked | |
| | Anti-lock brake report | |

The table above is a representative sample of applications created by combination of phone and OBD data. They are provided for illustration. There are many additional combinations of data that create useful applications.

It is contemplated that this data may be collected without any presentation to the user. The data may be published by drivers in other cars, governments, or interested businesses. Uses of the data include ranking of cars for performance and efficiency comparison. The data may also be used to accurately show traffic patterns, fuel usage in aggregate, and actual pollution generated,

It is recognized that the data collected and correlated has commercial value to parties beyond the driver. This value, especially if combined with the driver's identity, may be marketed and used for commercial purposes. These purposed uses include direct marketing to the driver and aggregate statistical data about drivers.

In addition, real time data from this invention may be used to provide accurate roadway conditions or smart roadways. These applications of the invention may provide significant value to society by reducing fuel consumption and traffic congestion. It is anticipated that the data will be presented to the driver. This data can be used to improve driving efficiency by checking expected acceleration (gas pedal) against actual acceleration (accelerometer) and traffic acceleration (network)

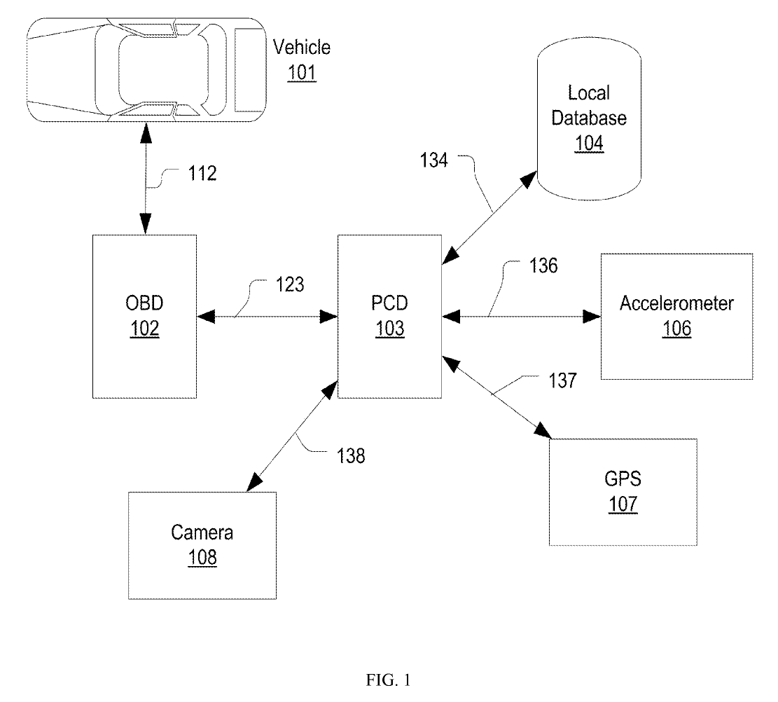

FIG. 1 is a block diagram of an vehicle 101 monitoring system that sends information from the vehicle 101 on-board diagnostic interface 102 to the driver's personal communication device, PCD 103, also known as a smart phone. The PCD 103 incorporates additional information from it's internal sensors such as an Accelerometer 106, global positioning system 107 or camera 108. The PCD uses information from both these internal sensors and the OBD 102 to track driver behavior. This data and the results of the analysis may be displayed to the driver or stored in the PCD 103 database 104 for later use. By combining both OBD and PCD data, a more complete understanding of the vehicle and driver performance may be determined.

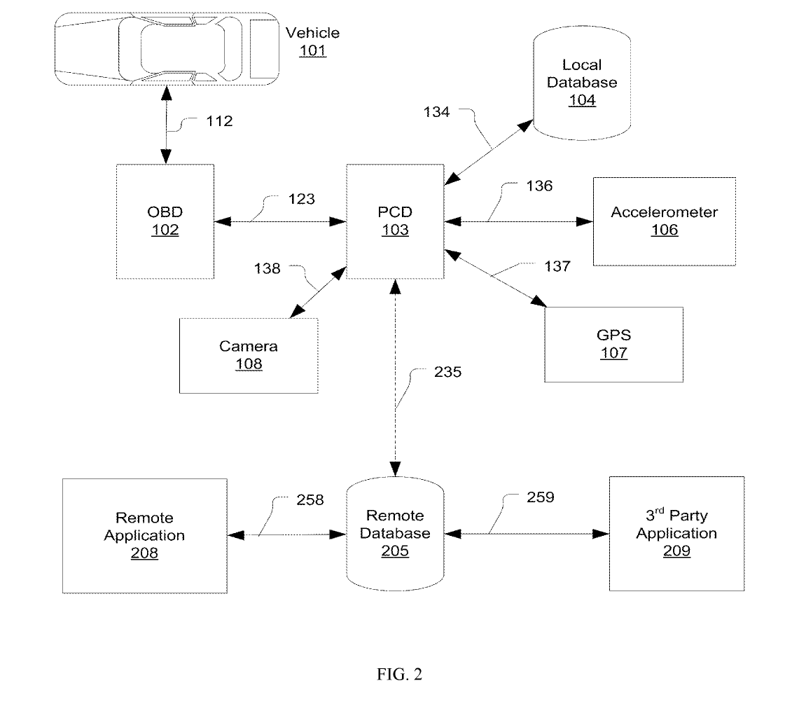

FIG. 2. is a block diagram extending the system from FIG. 1. to include systems outside of the vehicle 101. These systems are reached using the PCD 103 network connection 235. Such a connection may use cellular, wifi or similar data communication networks. Once a connection is 100 established, the PCD 103 may store vehicle or driver data on a remote database 205 or similar data repository. This database may be used in association with a remote application 208. The remote application may provide additional analysis, interface options or other value added capabilities for the driver. In addition, interested 3^{rd} parties may integrate their own applications 209. These integrations may include commercial offers based on the drivers' location, performance, or other observable 105 characteristics. Information from the remote database 205 may include data from other drivers. The link between the PCD 103 and the remote database 205 is bi-directional 235. This link 235 enables the PCD to retrieve information and analysis relevant to the driver based on their own or other driver's performance. The data may also include OBD 102 data sampled from many vehicles at many geographic locations.

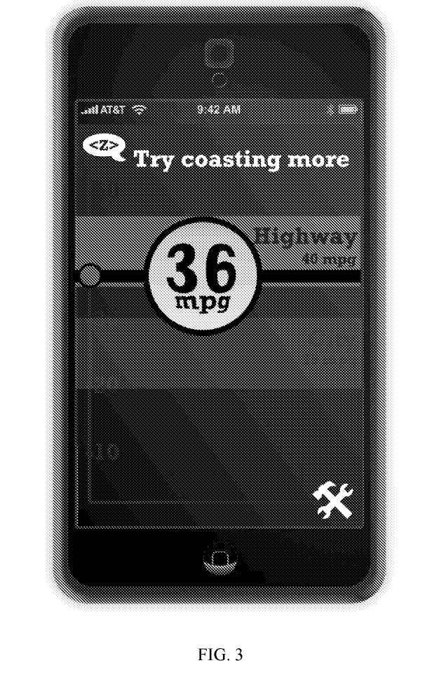

FIG. 3. is UI sample showing data that combines OBD and phone data. The circle in the center of the display moves vertically based on MPG efficiency data from the OBD interface. The circle moves horizontally based on acceleration data from the phone accelerometer. In addition, both phone GPS location and OBD speed data is used to determine which performance band (city or highway) is presented as a target for the user.

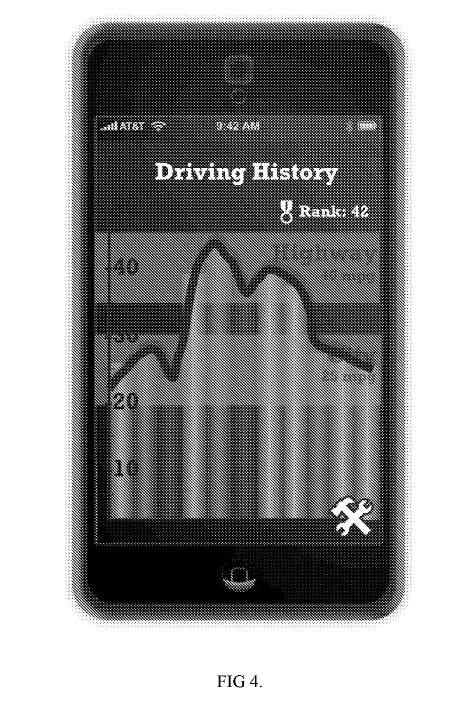

FIG. 4. is UI sample showing how the application displays additional information when the OBD indicates the vehicle is no longer in motion. This information reflects both locally tracked data and remote accessed information about other drivers and expected performance based on current location and traffic.

1. A process combining vehicle on-board diagnostic (OBD) and smart phone sensor data; a personal communication device in communication with a vehicle OBD interface; and sensors on both the vehicle and device able to detect vehicle location, performance, movement, environments, or other automotive characteristics.

2. The process of claim 1 in which the combined data is the fuel usage information and phone accelerometer

3. The process of claim 1 in which the combined data is the vehicle velocity and the phone location

4. The process of claim 1 in which the combined data is the tire pressure and phone accelerometer

5. The process of claim 1 in which the combined data is the trouble codes and the phone location

6. The process of claim 1 in which the combined data is the vehicle velocity and the phone accelerometer

7. The process of claim 1 in which drivers are alerted to ways to improve fuel efficiency based on presentation of the integrated data

8. The process of claim 1 in which drivers are alerted to ways to improve safety based on presentation of the integration data

9. The process of claim 1 in which combined data is stored on the smart phone

10. The process of claim 1 in which combined data is stored on a remote system via a network connection

11. The process of claim 1 in which data is used to analyze driving behaviors

12. The process of claim 1 in which data from other drivers is included in the analysis

13. The process of claim 12 in which data from other drivers is used to compute a relative ranking of drivers. For example, which drivers have the highest miles per gallon (MPG), lowest carbon output, or shortest travel time.

14. The process of claim 6 in which a traffic map is generated for use by other drivers

15. The process of claim 17 in which secondary analysis is performed. For example, analysis may be used to generate a pollution map is, calculate carbon output is calculated

16. The process of claim 1 in which personal information about the driver is included

17. The process of claim 16 in which the personal driving habits of the driver are monetized. For example, the personal driving habits are used for insurance rating purposes, to determine resale value of a vehicle, or calculate carbon output to track carbon credits.

18. The process of claim 16 in which the fault of an accident is determined

19. The process of claim 16 in which traffic violations are detected or refuted based on collected data from the OBD and PCD sensors

20. The process of claim 15 in which entities, including companies and cities, aggregate carbon use based on actual driving data
